(19) United States
(12) Patent Application Publication
(10) Pub. No.: US 2008/0193072 A1
(43) Pub. Date: Aug. 14, 2008

(54) Angular contact ball bearing, sprocket support assembly for use in a traveling speed reducer for a construction machine, and joint assembly for a robotic arm

(76) Inventors: Junichi Hattori, Kuwana (JP); Michio Hori, Kuwana (JP)

Correspondence Address: WENDEROTH, LIND & PONACK, L.L.P., 2033 K STREET N. W., SUITE 800, WASHINGTON, DC, 20006-1021, US

(21) Appl. No.: 12/068,299

(22) Filed: Feb. 5, 2008

(30) Foreign Application Priority Data
Feb. 13, 2007 (JP) 2007-32373

(51) Int. Cl. F16C 33/58; B25J 17/02; F16H 55/12

(52) U.S. Cl. 384/571; 74/479.01; 474/162

(57) ABSTRACT

An angular contact ball bearing includes a plurality of balls disposed between raceways of inner and outer bearing rings. Each ball is in contact with at least one of the raceways at two points having different contact angles from each other and located on an opposite side of a bearing centerline from a point at which each ball is in contact with the other of the raceways. The bearing is a full complement bearing, wherein the balls are arranged in a full complement. With this arrangement, it is possible to minimize the contact stress at the two contact points where the radial load and the axial load in one direction are supported, thereby reducing elastic deformation at the two contact points. This makes it possible to further increase the rigidity of the bearing.

### BACKGROUND OF THE INVENTION

This invention relates to an angular contact ball bearing suitable for use in a low speed region, a sprocket support assembly for use in a traveling speed reducer for construction machines that uses such angular contact bearings, and a joint assembly for robotic arms that uses such angular contact bearings.

Driving units having an output shaft that is rotated at a speed not exceeding 100 rpm, such as sprocket-driving units for construction machines and joint assemblies for robotic arms, include a driving source and a speed reducer. The speed reducer has an output shaft that is rotatably supported by a main bearing disposed between the output shaft and a driven member. Since loads are applied to the main bearing at a point outside the bearing, and thus moment loads are applied thereto, as such main bearings, angular contact ball bearings are typically used.

With such driving units, in order to improve the controllability of the attitude of the machine or arm, as well as the positioning accuracy of the driven member, increased rigidity of the main bearing against moment loads are required.

To meet this requirement, an angular contact ball bearing as shown in FIG. 5 is proposed which comprises an outer ring 11 having a raceway 12, an inner ring 13 having a raceway 14, and a plurality of balls 16 disposed between the raceways 12 and 14 and circumferentially held in position by a retainer 15, wherein each ball 16 is in contact with one of the raceways 12 and 14 at two points and in contact with the other of the raceways 12 and 14 at at least one point, with the two contact points a and b on the one of the raceways axially offset to one side of the bearing centerline C, and the contact points c and d on the other of the raceways, i.e. on the raceway 14 axially offset to the other side of the bearing centerline C (see e.g. JP patent application 2005-201294A).

The bearing shown in FIG. 5 can support only the axial load P in the direction shown by the white arrow in FIG. 5 and cannot support the axial load in the opposite direction.

By supporting the axial load P in one direction only at the two contact points a and b, the load applied to each of the contact points a and b is dispersed and decreases, so that the elastic deformation decreases. That is, the rigidity of the bearing against the axial load P increases. Needless to say, radial loads are also supported at two points.

But because there is a limit to the permissible contact pressure between the raceway 12 and each ball 16 at each of the contact points a and b, there is also a limit to the degree of improvement in the rigidity of the bearing by supporting the radial load and the axial load in one direction at two points.

An object of the present invention is to further improve the rigidity of an angular contact ball bearing of the type in which the radial load and the axial load in one direction are supported at two contact points.

### SUMMARY OF THE INVENTION

In order to achieve this object, the present invention provides an angular contact ball bearing comprising an outer ring having a first raceway, an inner ring having a second raceway, and a plurality of balls each in contact with at least one of the first and second raceways at two points having different contact angles from each other and located on an opposite side of a bearing centerline from a point at which each ball is in contact with the other of the first and second raceways, wherein the bearing is a full complement ball bearing.

In an arrangement in which the balls are circumferentially spaced from each other at equal intervals by a retainer to prevent contact between the balls, it is necessary that the bridges of the retainer have a sufficient width to ensure its strength against the pushing force applied thereto from the balls. This necessarily produces gaps between the adjacent balls along the pitch circle of the balls. Typically, the sum of such gaps is larger than the diameter of the balls. Such gaps reduce the number of balls, which in turn makes it difficult to disperse loads applied to the bearing.

The present invention was made based on the discovery from experience that when the bearing is used at a relatively low rotational speed, the contact between balls rarely results in fatal damage to balls. That is, according to the present invention, based on this discovery, a full complement bearing is used, in which the balls are disposed between the raceways of the inner and outer rings without using a retainer, thereby maximizing the number of balls. With this arrangement, it is possible to minimize the contact stress at the two contact points where the radial load and the axial load in one direction are supported, thereby reducing elastic deformation at the two contact points.

According to this invention, by using a full complement bearing, in which a full complement of balls are disposed between the raceways of the inner and outer rings, it is possible to further increase the rigidity of the bearing.

### BRIEF DESCRIPTION OF THE DRAWINGS

Other features and objects of the present invention will become apparent from the following description made with reference to the accompanying drawings, in which:

FIG. 1A is a partial front view of an angular contact ball bearing embodying the present invention, with its inner and outer rings partially removed;

FIG. 1B is a partial enlarged side view in vertical section of the angular contact ball bearing of FIG. 1A;

FIG. 2 is a partial enlarged view of FIG. 1A;

FIG. 3 is a partial sectional view of a joint assembly for a robotic arm in which two of the angular contact ball bearings embodying the invention are used;

FIG. 4 is a partial sectional view of a sprocket support assembly in a traveling speed reducer for a construction machine in which two of the angular contact ball bearings embodying the invention are used; and

FIG. 5 is a vertical sectional view of a conventional angular contact ball bearing.

### DETAILED DESCRIPTION OF THE PREFERRED EMBODIMENTS

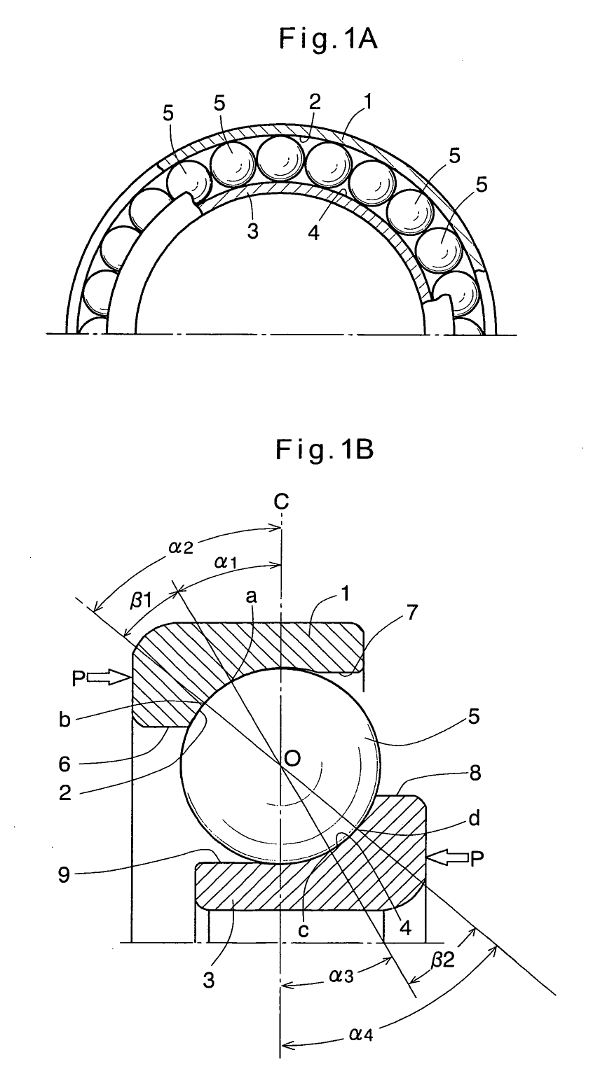

Now the embodiment of the invention is described with reference to FIGS. 1A and 1B. The angular contact ball bearing of this embodiment is a full complement ball bearing comprising an outer ring 1 having a raceway 2, an inner ring 3 having a raceway 4, and balls 5 received between the raceways 2 and 4. Each ball 5 is in contact with the raceway 2 of the outer ring 1 at at least two points a and b with different contact angles from each other on one side of the bearing centerline C and in contact with the raceway 4 of the inner ring 3 at at least one point (two points c and d in the figures) on the other side of the bearing centerline C. In this embodiment, the radial load and the axial load P in one direction are supported at the two contacts points a and b on the raceway 2 of the outer ring 1. The axial load P in the opposite direction is supported at the two points c and d on the raceway 4 of the inner ring 3.

Specifically, the raceway 2 of the outer ring 1 is formed on its radially inner surface between a shoulder 6 at one end thereof and a counterbore 7 at the other end thereof, and comprises two arcuate surfaces. The two contact points a and b with each ball 5 are each located on one of the arcuate surfaces, i.e. located on both sides of the abutment between the arcuate surfaces. The radially outer surface of the inner ring is symmetrical to the radially inner surface of the outer ring 3 with respect to the center point O of each ball 5. Thus, each ball 4 is in contact with the raceway 4 between the shoulder 8 at the other end of the inner ring 3 and the counterbore 9 at the one end of the inner ring 3 at the two contact points c and d.

Because each ball 5 contacts at least the raceway 2 at two points a and b having different contact angles from each other, the raceway 2 tends to become worn due to a difference in peripheral speed at the two contact points a and b. But as far as the bearing is rotated at a speed of not more than 100 rpm, the above peripheral speed is so small that wear is negligible.

The angles α1 and α3 (contact angles) of the contact points a and c with respect to the bearing centerline C are a minimum of 5°. The angles α2 and α4 (contact angles) of the contact points b and d with respect to the bearing centerline C are a maximum of 80°. The angles β1 and β2 between the respective contact points are determined within the above range. In the embodiment, the contact angles α1 and α2 are symmetrical to the contact angles α3 and α4 with respect to the center point C, and equal to the contact angles α3 and α4, respectively. But the contact angles α1 and α2 may not be symmetrical to and/or equal to the contact angles α3 and α4, respectively. Also, each ball may be in contact with only one of the inner and outer rings at two points.

The smaller the contact angles α1 and α3 at the contact points a and c, i.e. the contact points nearer to the bearing centerline C, the smaller the radial displacement. If the contact angle α1 or α3 is less than 15°, the balls 5 may move onto the counterbore 7 or 9.

The larger the contact angles α2 and α4 at the contact points b and d, i.e. the contact points remote from the bearing centerline C, the smaller the axial displacement. If the contact angle α2 or α4 is larger than 50°, the balls may move onto the shoulder 6 or 8.

The larger the spread angles β1 and β2, the smaller the overlap between the contact ellipses of the contact points a and b, and between the contact ellipses of the contact points c and d, respectively. Thus, the spread angles β1 and β2 are preferably as large as possible. Most preferably, the spread angles β1 and β2 are determined such that the contact ellipses do not overlap with each other.

Taking these factors into consideration, and from a practical viewpoint, the contact angles α1 and α3 are preferably 15 to 25°, the contact angles α2 and α4 are preferably 40 to 50°, and the spread angles β1 and β2 are preferably not less than 20°.

Needless to say, if each ball is in contact with the raceway 4 at one point, only the angles α1, α2 and β1 are determined in the above manner.

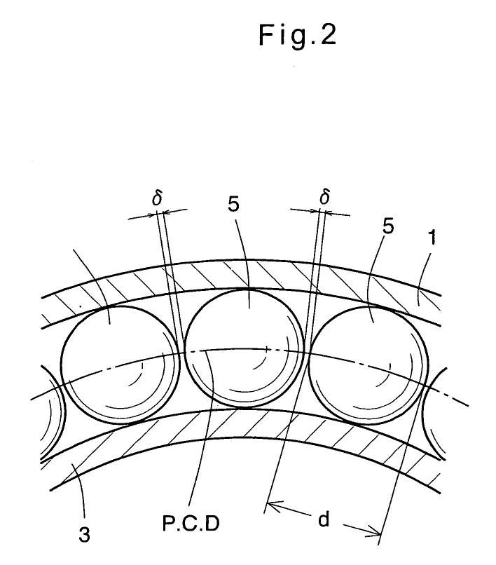

By determining the angles α1, α2 and β1 (and α3, α4 and β2) in the above manner, it is possible to ensure sufficient rigidity of the angular contact ball bearing according to this invention. Moreover, according to this invention, as shown in FIG. 2, the gaps 6 between the adjacent balls 5 along the pitch circle (PC) are determined such that their sum does not exceed the diameter d of the balls 5, and no retainer is provided. By determining the gaps δ to such a small value, the bearing according to the invention can sufficiently perform its expected function without a retainer.

By using a full complement ball bearing, i.e. by omitting a retainer, it is possible to minimize contact stresses between the balls 5 and the raceways 2 and 4 at the respective contact points a to d. This makes it possible to further reduce elastic deformation at the contact portions a to d, compared to bearings with a retainer.

Thus, it is possible to further increase the rigidity of the angular contact ball bearing according to the invention.

Contact between any adjacent balls 5 never results in fatal damage as long as the bearing is used at a low speed not exceeding 100 rpm. By using ceramic balls as the balls 5, or by applying a wear-resistant coating on the balls 5, it is possible to improve the wear resistance and rigidity of the balls 5, too.

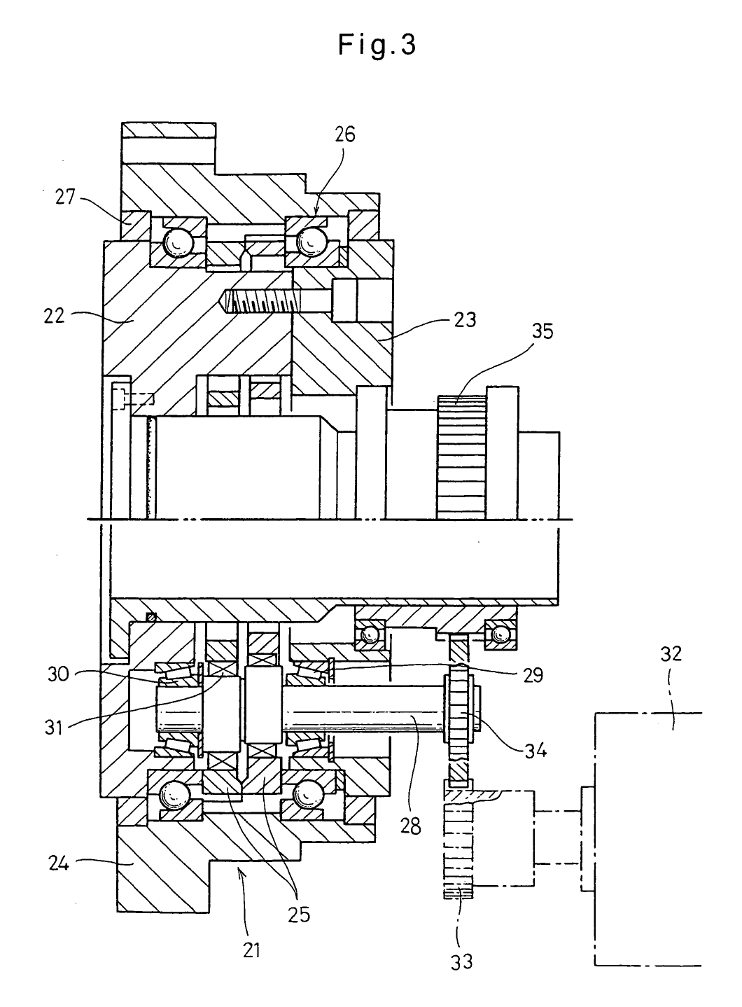

FIG. 3 shows a joint assembly for a robotic arm in which angular contact ball bearings according to the present invention are used. The joint assembly for a robotic arm shown in FIG. 3 includes a speed reducer 21 in the form of an eccentric differential speed reducer. The speed reducer 21 is configured to drive a pivot member 23 fixed to the robotic arm through its output shaft 22.

Specifically, the speed reducer 21 includes a case 24 fixed between the pivot member 23 and the base seat, the output shaft 22, which is in the form of a carrier mounted in the case 24 and fixed to the pivot member 23, and a pinion 25 with external teeth that mesh with pin teeth provided on the inner periphery of the case 24. Main bearings 26 are mounted between the output shaft 22 and the case 24.

The main bearings 26 comprise two of the angular contact ball bearings according to the above-described embodiment in the form of back-to-back duplex bearings. The main bearings 26 are disposed between the outer periphery of the output shaft 22 and the inner periphery of the case 24 to support the output shaft 22 so as to be rotatable relative to the case 24. Between flanges on both sides of the output shaft 22 and the respective ends of the case 24, seal members 27 are disposed. The main bearings 26 are lubricated with grease.

A plurality of crank pins 28 are each inserted in one of through holes formed in the pinion 25. The crank pins 28 are rotatably supported by the output shaft 22 through bearings 29 and 30. Each crank pin 28 has two eccentric crank portions at its central portion. The crank portions are inserted in and supported by the respective holes of the pinion 25 through needle bearings 31.

A driving motor 32 is mounted on the pivot member 23. An external gear 33 fixed to the output shaft of the motor 32 directly meshes with an external gear 33 fixed to one of the crank pins 28. Thus, rotation torque of the external gear 33 is transmitted to the external gear 34, thereby rotating the crank pin 28.

The external gear 34 also directly meshes with a gear 35 rotatably supported by the pivot member 23 through a bearing. The gear 35 also meshes with the crank pins other than the crank pin 28 directly connected to the motor. Thus, the rotation torque transmitted from the external gear 34 to the gear 35 is distributed to the other crank pins.

With this arrangement, when the crank pins 28 are rotated once, the center of the pinion 25 rotates once about the axis of the speed reducer. In this arrangement, because the number of the external teeth of the pinion 25 is smaller than the number of the pin teeth of the case 24, and because the case 24 is fixed to the base seat, the rotation transmitted to the crank pins 28 is reduced in a high ratio and transmitted to the output shaft 22 and the pivot member 23.

By using angular contact ball bearings according to this invention to support the output shaft of the speed reducer 21, to which driving force for moving the robotic arm is applied, because the bearings according to the invention is high in rigidity, it is possible to reduce the size and weight of the joint assembly for a robotic arm. This increases its rigidity and reduces the inertia applied to the joint assembly, which in turn makes it possible to improve positional accuracy and the control response.

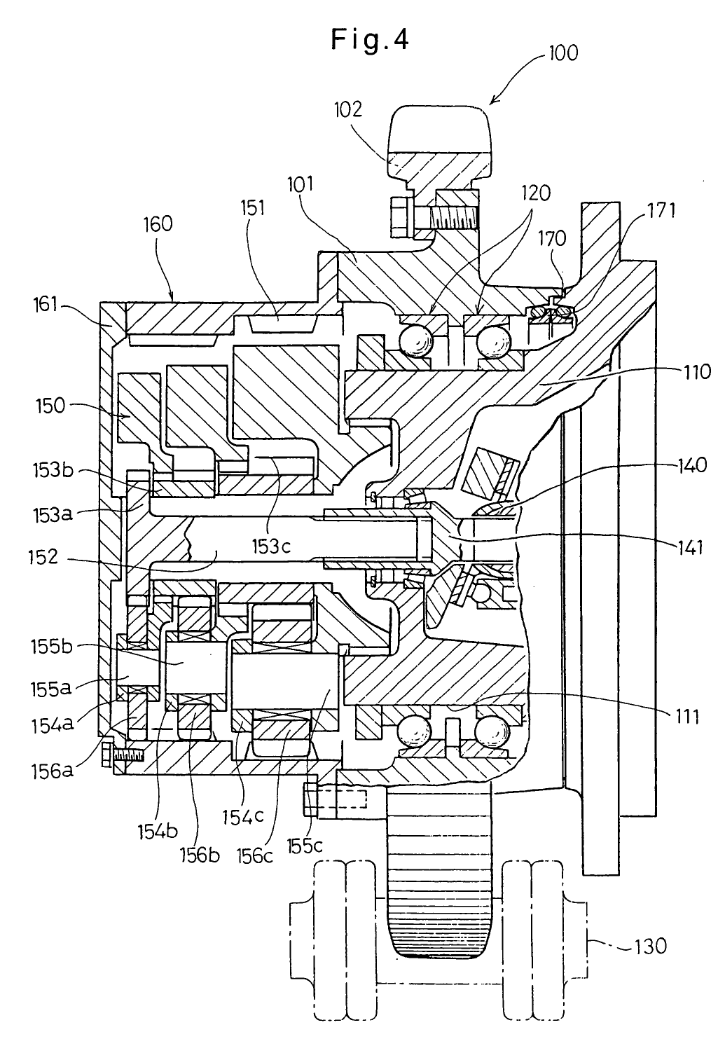

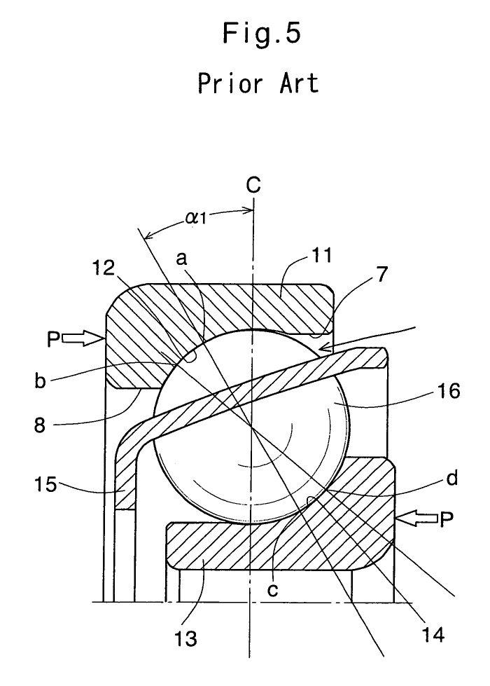

FIG. 4 shows a sprocket support assembly of a traveling speed reducer for use in a construction machine in which angular contact bearings according to the invention are used.

The sprocket support assembly of a traveling speed reducer for use in a construction machine shown in FIG. 4 includes a sprocket 100, a housing 110 fixed to a moving object, and angular contact bearings 120 mounted between the inner periphery of the sprocket 100 and the outer periphery of the housing 110.

This type of traveling speed reducers are used in caterpillar construction machines such as hydraulic shovels, shovel excavators, bulldozers, loaders, trenchers, dampers, scrapers and pipelayers, and are especially frequently used in shovels and bulldozers.

The sprocket 100 comprises a rotary drum 101, and a sprocket wheel 102 mounted around the rotary drum 101. A caterpillar 130 is trained about the sprocket wheel 102.

The housing 110 is fixed to a side frame (not shown) of a hydraulic shovel or a bulldozer.

The housing 110 has a radially inner portion in which a hydraulic motor 140 is mounted, and a radially outer portion formed with a bearing seating surface 111 for mounting the angular contact bearings 120 between the seating surface 111 and the radially inner surface of the rotary drum 101.

The angular contact bearings 120 are ones embodying the present invention, and support the sprocket 100 so as to be rotatable relative to the housing 110.

The angular contact bearings 120 are combined in a back-to-back arrangement, and a preload is applied to each of them.

The hydraulic motor 140 has an output shaft 141 connected to a speed reducer 150 through which the rotation of the output shaft 141 is reduced and transmitted to the sprocket 100. The speed reducer 150 is mounted in a casing 160 secured to the end of the rotary drum 101 opposite to its end where the hydraulic motor 140 is mounted. A detachable cover 161 is fitted on the end surface of the casing 160 opposite to its end that is secured to the rotary drum 101.

The speed reducer 150 comprises a ring gear 151 provided on the inner periphery of the casing 160, a first sun gear 153a provided on a propeller shaft 152 coupled to the output shaft 141 of the hydraulic motor 140, and a planetary gear reduction unit disposed between the first sun gear 153a and the ring gear 151. The planetary gear reduction unit is a known one comprising a first carrier 154a, first pins 155a, first planetary gears 156a, a second sun gear 153b, a second carrier 154b, second pins 155b, second planetary gears 156b, a third sun gear 153c, a third carrier 154c, third pins 155c, and third planetary gears 156c.

When the hydraulic motor 140 is driven, the planetary gear reduction unit increases torque. The third carrier 154c, which is the final reduction element, is coupled to the housing 110 and thus is nonrotatable. Thus, the third planetary gears 156 rotate about their respective own axes, and their rotation about their own axes rotates the ring gear 151, and thus rotates the sprocket wheel 102, which is coupled to the ring gear 151 through the casing 160 and the rotary drum 101. The caterpillar 130 thus moves, and so does the construction machine.

Between the rotational sliding portions of the rotary drum 101 and the housing 110, a labyrinth seal 170 is provided to prevent entry of dirt, muddy water, etc. from outside. Inside the labyrinth seal 170, a floating seal 171 is further provided. The floating seal 171 is a know seal comprising a pair of ring members each formed with an O-ring groove facing the inner periphery of one of the rotary drum 101 and the housing 110, and O-rings each received in one of the O-ring grooves. The floating seal 171 prevents leakage of oil from the traveling speed reducer and entry of foreign matter into the speed reducer.

With this sprocket support assembly, since the angular contact bearings 120 are high in rigidity, the load on the floating seal 171 decreases. Also, it is possible to reduce the wall thickness of the rotary drum 101, and to reduce the size of the speed reducer.

By reducing the wall thickness of the rotary drum 101, it is possible to join the rotary drum 101 and the casing 160 by welding, and thus to eliminate the need to prepare bolts and form bolt holes, thereby reducing the manufacturing cost.

What is claimed is:

1. An angular contact ball bearing comprising an outer ring having a first raceway, an inner ring having a second raceway, and a plurality of balls each in contact with at least one of the first and second raceways at two points having different contact angles from each other and located on an opposite side of a bearing centerline from a point at which each ball is in contact with the other of the first and second raceways, wherein said bearing is a full complement ball bearing.

2. A joint assembly for a robotic arm comprising a speed reducer to which a driving force for moving the robotic arm is applied, and the angular contact ball bearing of claim 1, which is mounted on an output shaft of the speed reducer.

3. A sprocket support assembly for a traveling speed reducer in a construction machine, said sprocket support assembly comprising a sprocket, a bearing housing fixed to a moving object, and the angular contact ball bearing of claim 1, which is mounted between an inner periphery of said sprocket and an outer periphery of said housing.
